(19) United States
(12) Patent Application Publication
(10) Pub. No.: US 2016/0107249 A1
(43) Pub. Date: Apr. 21, 2016

(54) A SHEAR

(71) Applicant: PRIMETALS TECHNOLOGIES, LIMITED, London (GB)

(72) Inventors: Michael CARTWRIGHT, Doncaster (GB); Peter WOOTTON, Dronfield (GB)

(21) Appl. No.: 14/894,622

(22) PCT Filed: May 6, 2014
(86) PCT No.: PCT/EP2014/059190

§ 371 Date: Nov. 30, 2015

(30) Foreign Application Priority Data
Jun. 3, 2013 (GB) 1309859.5

(51) Int. Cl. B23D 35/00; G01B 21/16; G05B 15/02; B23D 15/04

(52) U.S. Cl. CPC B23D 35/005; B23D 15/04; G01B 21/16; G05B 15/02

(57) ABSTRACT

A shear has a moveable blade assembly (7); a second fixed blade assembly; a first sensor (22) mounted on the first blade assembly; a second sensor (21) mounted on the second blade assembly; and a first sensor reference block (20) fixedly mounted relative to a fixed datum (23).

### CROSS-REFERENCE TO RELATED APPLICATIONS

The present application is a 35 U.S.C. §§371 national phase conversion of PCT/EP2014/059190, filed May 6, 2014, which claims priority of British Patent Application No. 1309859.5, filed Jun. 3, 2013, the contents of which are incorporated by reference herein. The PCT International Application was published in the English language.

### TECHNICAL BACKGROUND

This invention relates to a shear and a method of blade gap measurement in the shear, in particular for rolling cut type shears, although it is applicable for other types of shears.

### BACKGROUND OF THE INVENTION

In the shearing of metal, particularly thicker metal strip and plates, a very common type of shear is the rolling cut type of shear in which one straight blade and a second curved blade operated by cranks or hydraulic cylinders perform a rolling type cut. In this type of shear and in many other types of shear, such as rotary side trim shears, or slitting shears, the blade gap needs to be adjusted according to the thickness and the strength of material being sheared and the blade gap needs to be set accurately in order to get the best cut quality and to minimize the blade wear.

A very common method of adjusting the blade gap in a dividing shear is disclosed in GB999188. The blade gap is adjusted using wedges which are operated by a lead screw to move the top knife assembly towards or away from the fixed bottom knife and thus adjust the blade gap. The top knife assembly slides against the wedges and on the opposite side of the knife assembly from the wedges are slides, held against the wedges by springs, or by other wedges, which push the top knife assembly against the wedges.

Many other types of blade gap adjustment system are known, but although there are mechanisms for blade gap adjustment, it is difficult to obtain a measurement of the blade gap as the basis for making the adjustment.

### SUMMARY OF THE INVENTION

In accordance with a first aspect of the present invention, a shear comprises a first moveable blade assembly; a second fixed blade assembly; a first sensor mounted on the first blade assembly; a second sensor mounted on the second blade assembly; and a first sensor reference block fixedly mounted relative to a fixed datum (i.e., a basis for measuring).

Mounting the reference block at a fixed position relative to a fixed datum enables accurate measurement of the blade gap.

Preferably, more than one sensor is mounted on each blade assembly.

Preferably, the more than one sensors are spaced apart on the blade assembly outboard of the shearing part of each blade.

Preferably, the first blade assembly comprises a first blade and a first blade holder.

Preferably, the second blade assembly comprises a second blade and a second blade holder.

Preferably, each sensor is mounted on the blade holder.

Preferably, the sensors comprise non-contact sensors.

Preferably, the sensors comprise one of inductive, capacitative, or optical sensors.

Preferably, the shear further comprises a controller to receive measurements from the sensor, wherein the sensor is inductively coupled to the controller.

Preferably, the shear further comprises a power supply for the sensor, wherein the sensor is inductively coupled to the power supply.

Preferably, the shear comprises one of a rolling cut shear having a first straight blade and a second curved blade; or a slitting shear.

In accordance with a second aspect of the present invention, a method of determining blade gap in a shear comprising a first moveable blade assembly; a second fixed blade assembly; a first sensor mounted on the first blade assembly; a second sensor mounted on the second blade assembly; and a first sensor reference block fixedly mounted relative to a fixed datum comprises providing stored reference data, measured relative to a first datum, for location of the second sensor and providing stored reference data, measured relative to the first datum, for location of the first sensor reference block; providing stored reference data, relative to a second datum, for location of the first sensor; and in one measurement period of a cutting cycle, using the first sensor to determine a distance to a cutting face of the second blade assembly and using the second sensor to determine a distance to a cutting face of the first blade assembly; in another measurement period of the cutting cycle, using the first sensor to determine a distance to the first sensor reference block; and in a controller calculating a blade gap from the stored reference data and determined distances.

Preferably, each measurement period is synchronized with a movement of the first blade assembly.

Preferably, the calculated blade gap comprises the distance from the first datum to the location of the second sensor; plus the sum of the distance between the first sensor and the cutting face of the second blade and the distance between the second sensor and the cutting face of the first blade; less the sum of the distance from the first datum to the location of the reference block and the distance from the first sensor to the first sensor reference block.

Preferably, the method further comprises determining a required blade gap from reference data relating to material thickness for material to be sheared; comparing the required blade gap with the calculated blade gap; and if the result of the comparison exceeds a predetermined threshold range, adjusting the blade gap accordingly.

### BRIEF DESCRIPTION OF THE DRAWINGS

An example of a shear and a method of determining blade gap in a shear will now be described with reference to the accompanying drawings in which:

FIG. 1 illustrates a conventional, indirect blade gap adjustment system;

FIG. 2 illustrates a conventional blade gap adjustment system incorporating a sensor;

FIG. 3 shows an example of a shear according to the present invention in its lower position;

FIG. 4 shows the shear of FIG. 3 in its raised position;

FIG. 5 illustrates the calculation of the blade gap for the examples of FIGS. 3 and 4; and,

FIG. 6 is a flow diagram of an example of a method of the present invention.

### DESCRIPTION OF PRIOR ART

In some of the prior art blade gap adjustment mechanisms, sensors are provided to determine the position of the adjustment mechanism, such as encoders on the shafts which operate the screw jacks in GB999188. The system calculates the position of the adjustment mechanism and adjusts the blade gap as required for different materials.

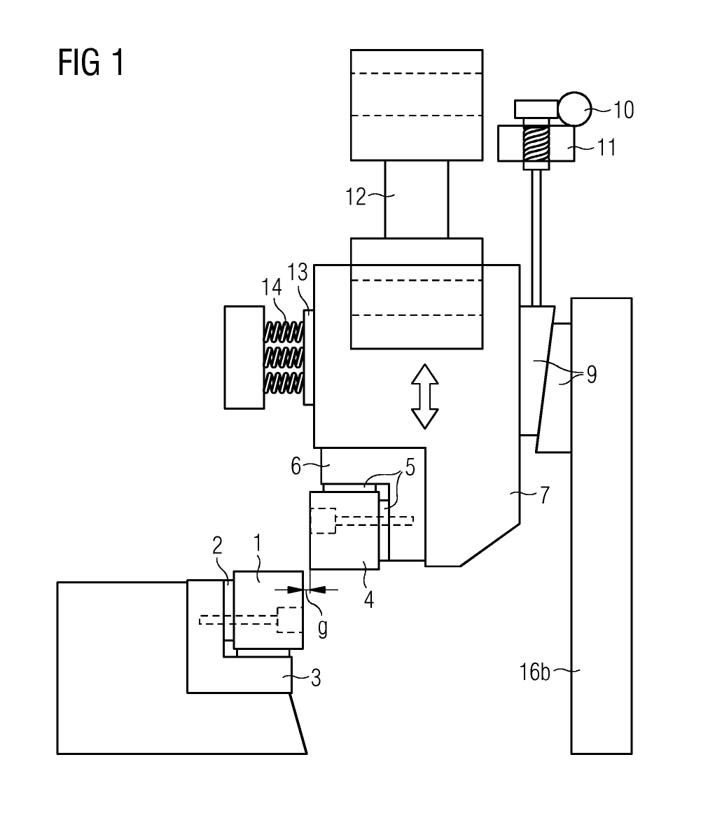

However these types of blade gap adjustment systems, for example as illustrated in FIG. 1, are indirect. A bottom blade 1 is mounted via shims 2 in a bottom blade holder 3. A top blade 4 is mounted via shims 5 in a top blade holder 6. The top blade holder 6 is fitted to a top knife beam 7 which moves in response to operating cranks 12 when carrying out shearing. Between the top knife beam 7 and a support 16b are wedges 9 which allow adjustment of the blade gap, g. The wedges 9 move under the control of the motor and encoder 10 on screw jacks 11. The top knife beam 7 is held against the wedges by slides 13 and springs 14.

In this type of arrangement, the blade gap is not measured directly, but the movement of the gap adjustment system relative to a datum setting (a basis for measuring) is measured. In order to know the actual blade gap, a manual measurement is usually made, typically when the shear is installed, or after a blade change, in order to calibrate the blade gap adjustment system. There are several problems with this type of system. First of all the wedges 9 and the slides 13 gradually wear, so that the blade gap is no longer correct and the wear on the wedge faces and the slides changes the calibration. This requires that the blade gap is measured manually from time to time in order to re-calibrate the blade gap adjustment system. However, manual measurement is a difficult and dangerous job. It is hard to measure the blade gap whilst in use, as scrap passes through.

A second problem concerns the blade change. In most current designs the blades are supported in blade holders 3, 6 and are shimmed 2, 5 in order to get the correct dimensions from the back of the blade holder to the cutting edge of the blade. When the blade 1, 4 is changed, it is reground and then it has to be re-shimmed to get this dimension correct and the correct parallelism. If the blade 1, 4 is not shimmed correctly then the blade gap will not be correct.

U.S. Pat. No. 7,596,879 discloses a method for measuring the cutting gap in a rotary side trim shear. Two measuring devices are used when the shear is not in operation. The position of the lower blade and the position of the upper blade are measured relative to a fixed position on a machine frame and then the smaller measurement is subtracted from the larger measurement to determine the cutting gap. However, in the examples given, only one of the sensors actually measures the distance to the cutting edge of the blade directly. The other sensor measures the distance to the blade holder. The method takes advantage of the fact that in this type of rotary side trim shear, the blade holder is flush with the surface of the blade and therefore a measurement to the surface of the blade holder is an accurate indication of the position of the surface of the blade itself. However, in a rolling cut type shear, it is not possible to apply the system disclosed in U.S. Pat. No. 7,596,879 because there is no equivalent to a surface in flat surface contact with the blade. In a rolling cut shear, the blade and blade holder are not flush, in order to protect the blade holder.

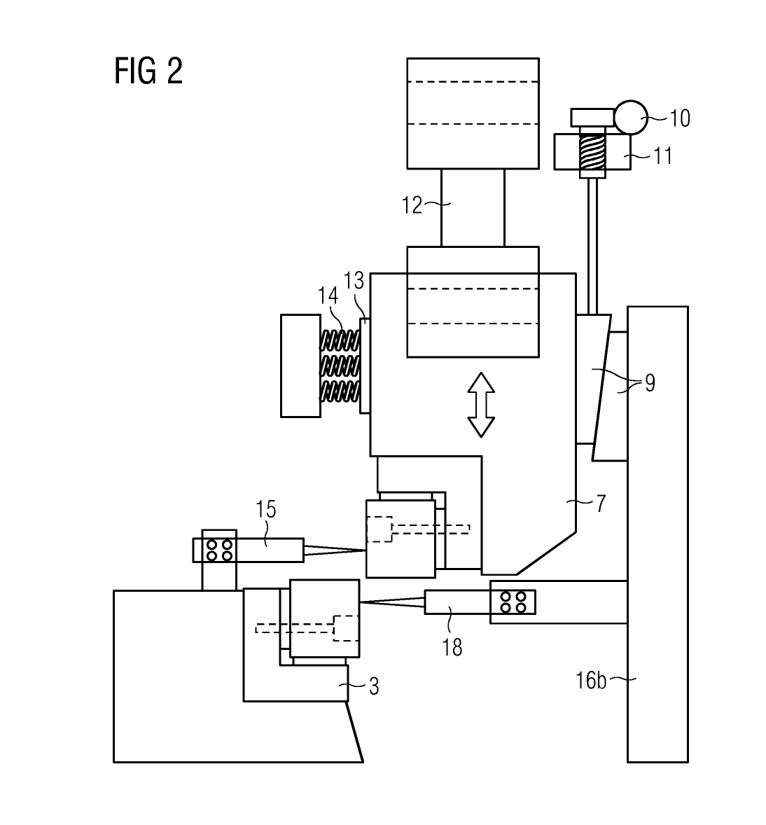

FIG. 2 illustrates an example arrangement with one sensor 15 attached to a fixed support 16a, such as the main frame looking at the surface 17 of the top blade 4 and one sensor 18 attached to the fixed support 16b looking in the opposite direction at the surface 19 of the bottom blade 2. The sensors are positioned at the outboard ends of the blades 1, 4, toward the end toward the viewer and the end away from the viewer in FIG. 2, for example, and outside the part of the blade which is actually used for cutting. However, in practice on a rolling cut type shear for a large plate mill, it is very difficult to get a reliable, convenient and accurate blade gap measurement using this method.

One problem is that the size of the machine means that the distance between the fixed supports 16a, 16b for the two sensors 15, 18 is large and this introduces errors due to thermal expansion of the equipment and deflection of the equipment. Another issue is that the bottom sensor 18 is vulnerable to damage from scrap pieces of metal from the cutting operation. Another problem is that the bottom sensor 18 gets in the way of the blade change. During the blade change the blade assemblies are usually removed in the direction away from the bottom blade i.e. towards the bottom blade sensor. Thus, unless the sensor has a very large stand-off (which makes it less accurate) the bottom sensor has to be moved for blade change. Furthermore, with the design illustrated in FIG. 2 it is not easy to repair, replace or calibrate the sensors

### DESCRIPTION OF EMBODIMENTS

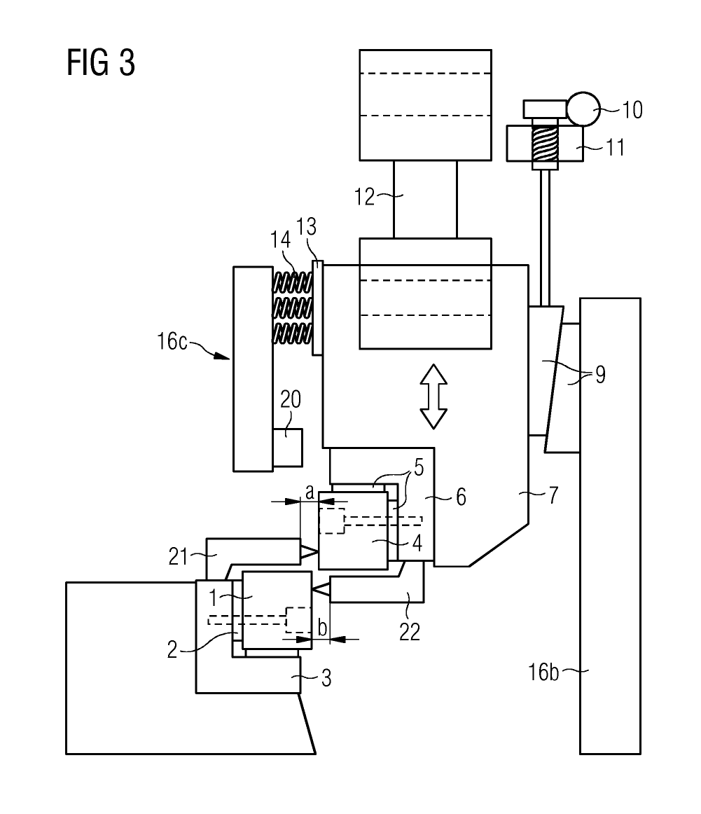

The present invention provides a system which addresses the problems of conventional blade gap measurement. An example of a shear according to the present invention and a method of operating the shear is illustrated in FIGS. 3 to 6. As before, as shown in FIG. 3, top and bottom blades 4, 1 are mounted in respective blade holders 6, 3 via respective shims 5, 2. The shims are used to set the edge of the blade correctly with respect to the back of the blade holder. The bottom blade and blade holder are fixed in position. The top blade holder 6 is fitted to a top knife beam 7 which moves in response to operating cranks 12 when carrying out shearing. Between the top knife beam 7 and support 16b are wedges 9 which allow adjustment of the blade gap. The blade gap required depends upon the metal thickness. The wedges 9 are moved under the control of the motor and encoder 10 on one or more screw jacks 11 to adjust the whole top knife assembly position for cutting. If there are multiple screw jacks, this gets complicated to set up again after the faces have worn. The top knife beam 7 is held against the wedges by slides 13 and springs 14. For both the wedges and the slides, there may be different wear at each axial end of the rolling blade because one end is always loaded and the other end is only loaded if the material being sheared is wide.

Distance sensors 22, 21 are mounted on the top and bottom blade holders 6, 3 as illustrated. The sensors are mounted at the outboard ends e.g., toward and away from the viewer, of the top and bottom blade holders, so that the sensors are clear of the main part of the blade where the shearing actually takes place. Mounting the sensors on the blade holder makes maintenance easier as the blade holder is removed from the shear for maintenance. There may be just one sensor on each of the top and bottom blade holders or there may more than one sensor. Using two sensors on each blade holder, one at each axial end, allows measurement of the blade gap at both ends of the blades 1, 4. An arrangement with sensors at each end is preferred because the average gap can be calculated and the sensors also provide information about any misalignment of the blades. The type of sensor is not restricted, but preferably the sensors are non-contact type sensors, such as inductive, capacitive or optical (laser) type sensors. This is convenient for maintenance and blade change.

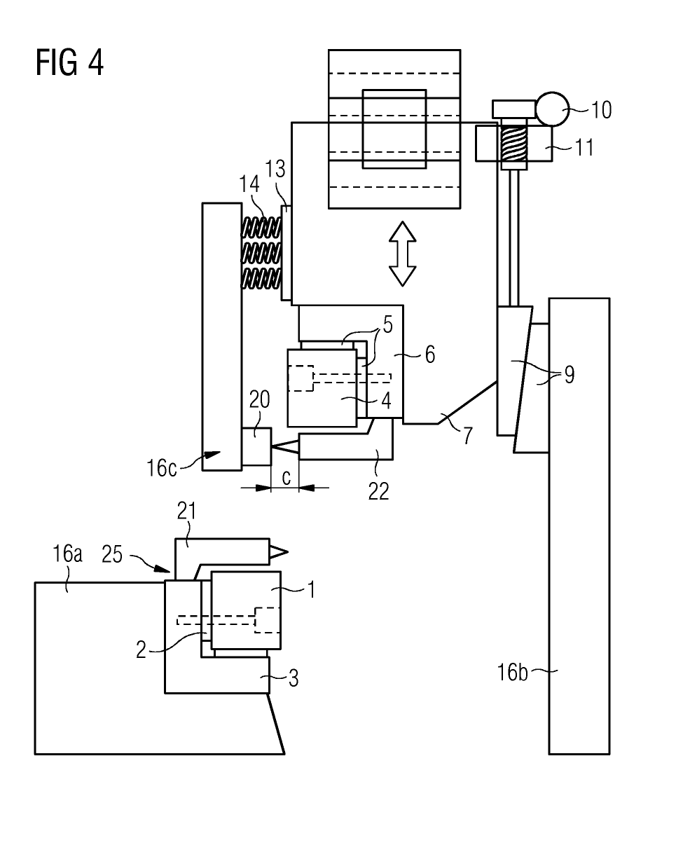

The example of FIG. 3 illustrates the moment during the rolling cut action when, for this side of the shear, the blades 1, 4 are almost at their closest approach to each other. At this moment and for a short time either side of this moment, the position sensor 22, which is mounted on the upper blade holder 6, measures the distance ‘b’ to the lower blade. At the same time the position sensor 21, which is mounted on the lower blade holder 3, measures the distance ‘a’ to the upper blade. These two measurements ‘a’ and ‘b’ are not sufficient to determine the blade gap, but when the upper blade 4 is moved to the higher position by the operating cranks, as shown in FIG. 4, the sensor 22 mounted on the upper blade holder 6 makes a second measurement ‘c’ to a fixed reference block 20, which is mounted on a support 16c and is part of the same shear structure as the supports 16a, 16b. The sensors, in particular the bottom sensor, do not get in the way of the blade change because they are attached to the blade holders and are removed as part of the blade change procedure.

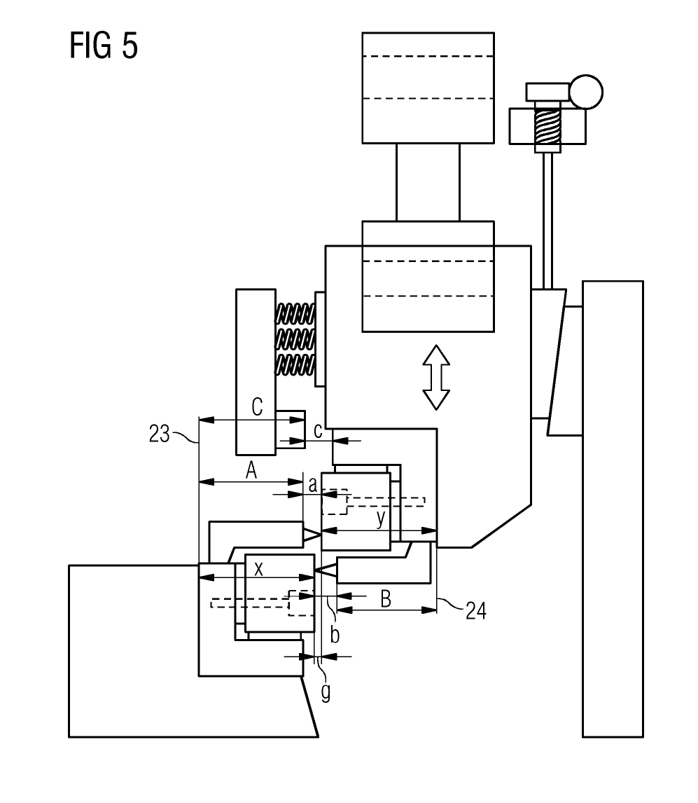

The measurements ‘a’, ‘b’ and ‘c’ are made during time periods which are synchronized with the movement of the moving blade assembly. The calculation of the blade gap from these measurements ‘a’, ‘b’ and ‘c’ is illustrated from FIG. 5. Distances A, B and C are assumed to be constant. These values are obtained by measurement and stored as reference data for subsequent calculations of the blade gap. C is a fixed offset between a datum (basis for measuring) 23 and the first sensor reference block 20 which must be calibrated when the shear is first installed. A—the distance from the second position sensor 21 to the first datum 23 and B—the distance from the first position sensor 22 to a second datum 24, need to be established by calibrating the distance sensors 21, 22 relative to the back surfaces 25, 26 of their respective blade holders 3, 6, so that the measurements B+b and A+a are accurate. This is most easily done during maintenance because the distance sensors 21, 22 are mounted on the blade holders 1, 4 and therefore the distance sensors are removed from the shear when the blades are changed. For new systems, the calibration of the distance sensors may be carried out before the system is first installed.

The unknown distances in FIG. 5 are the distance x from the back surface 25 of the bottom blade holder 3 to the front surface 19 of the bottom blade 1, the distance y from the back surface 26 of the top blade holder 4 to the front surface 19 of the blade, and the blade gap g. These can easily be calculated from using the three measurements a, b, c and the known stored distances A, B and C.

x=C+c−b

y=C+c+B−(A+a)

g=C+c+B−(x+y)=A-C+a+b−c

In general the position of the fixed datum block 20 is such that the distance A-C is relatively small and hence the accuracy of the calculation of the blade gap ‘g’ is increased with respect to prior art methods, because the measurements a, b and c have a good resolution and accuracy. The measurement is more accurate than the system illustrated in FIG. 2 because the sensors can have very short stand-offs from the cutting edge of the blades and the measurement is less likely to drift due to temperature changes because the distance. A-C is relatively small and the blade gap is calculated by the addition and subtraction of relatively small distances. While A and B may be accurately measured and calibrated during maintenance when the blade assemblies 1, 3 and 4, 6 are removed from the shear, the distance C needs to be calibrated when the shear is first installed. When the blades are re-ground during maintenance, there is no need to change the shims 2, 5 in order to make sure that the distances x and y are the same. The blades can simply be re-installed in the shear and the blade gap measurement system may then be used to determine the blade gap. Together with the gap adjustment system, the gap g may then be set correctly.

The sensors 21, 22 require power and must transmit measurements to a shear control system (not shown). Using plugs and sockets and cables would involve disconnecting and reconnecting the sensors at each blade change. In a preferred embodiment, the sensors obtain their power and transmit their signals back to the shear control system 16 via inductive coupling devices, which are well known. The inductive coupling means that there is no need to connect and disconnect cables when the blades are changed, the wiring stays in the holder and the sensor is removable. The blade, blade holder and sensors are removed from the supports 16a, 16b and top knife beam 7 for a blade change, so the sensors 21, 22 mounted on the blade holders can easily be checked, re-calibrated, or repaired when the blades are changed.

Removing the sensor from the shear together with the blade holder and blade during a blade change makes it easy to check, re-calibrate and repair the sensors if required. Any wear of the wedges 9 and slides 13 in the gap adjustment system is automatically taken care of by using the blade gap measurement system to provide feedback into the blade gap adjustment system.

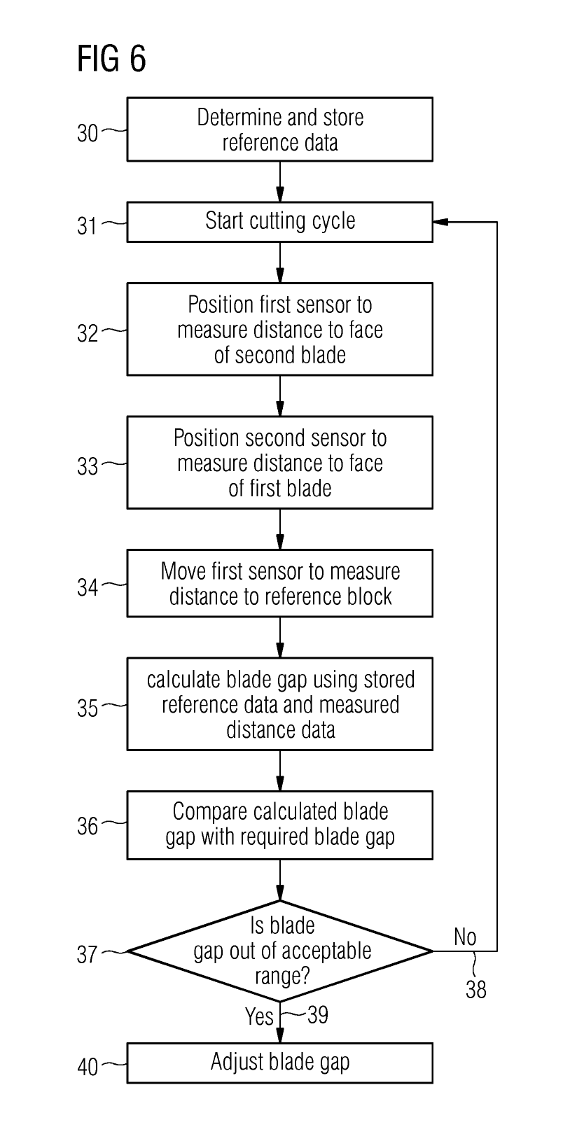

FIG. 6 is a flow diagram showing one example of the method of the present invention. Reference data relating to distances A, B and C is determined and stored 30 for later use by the shear control system 16. A cutting cycle is started 31 and one or more sensors which are mounted on a moving blade assembly are positioned 32 such that at least one sensor 22 measures the distance to the cutting face of the fixed blade during one part of a cutting cycle. At the same time, the second sensor 21 is in position 33 to measure the distance to the face of the first blade. In another part of the cutting cycle, the moving blade assembly is moved 34 so that the first sensor is now in a second position, where the first sensor measures the distance to a fixed datum 23 and the sensor reference block 20. The time periods when the measurements are taken are synchronized with the movement of the blade assembly. From the stored data and the measured data, a blade gap g is calculated 35 as described above. Having calculated the blade gap, this may be used by a controller 16 to determine whether any blade gap adjustment is required. In this case, the calculated blade gap is compared 36 with a known blade gap required for a particular thickness of material to be sheared. If the comparison shows that the calculated blade gap falls outside an acceptable range of tolerance 39, then adjustment 40 is made to the blade gap. If the calculated blade gap is close enough 38 to the required blade gap, then the blades are not adjusted, but the next cutting cycle 31 starts.

1. A shear comprising:
a first moveable blade assembly with a blade having a first edge;
a second fixed blade assembly with a blade having a second edge facing to cooperate with the first edge to define the shear;
a first distance sensor mounted on the first blade assembly and configured and aimed to measure distance to the second blade assembly; a second distance sensor mounted on the second blade assembly and configured and aimed to measure distance to the first blade assembly; and
a first sensor reference block fixedly mounted relative to a fixed datum, and the first sensor being selectively movable to oppose the first sensor reference block.

2. A shear according to claim 1, wherein more than one of the sensors is mounted on each blade assembly.

3. A shear according to claim 2, wherein the more than one sensors on each blade assembly are spaced apart on the respective blade assembly at locations outboard of the shearing part of each blade.

4. A shear according to claim 1, wherein the first blade assembly comprises a first blade and a first blade holder holding the first blade.

5. A shear according to claim 4, wherein the second blade assembly comprises a second blade and a second blade holder holding the second blade.

6. A shear according to claim 1, wherein each sensor is mounted on a respective one of the blade holders.

7. A shear according to claim 1, wherein each sensor comprises a non-contact sensor.

8. A shear according to claim 7, wherein each sensor comprises one of an inductive, capacitative, or optical sensor.

9. A shear according to claim 1, further comprising a controller configured to receive measurements from the sensors, wherein each sensor is inductively coupled to the controller.

10. A shear according to claim 1, further comprising a power supply for the sensor, wherein the sensor is inductively coupled to the power supply.

11. A shear according to claim 1, wherein the shear comprises one of a rolling cut shear having a first straight blade and a second curved blade; or a slitting shear.

12. A method of determining a blade gap in a shear;
the shear comprising:
a first moveable blade assembly with a blade having a first edge;
a second fixed blade assembly with a blade having a second edge facing to cooperate with the first edge to define the shear;
a first distance sensor mounted on the first blade assembly and configured and aimed to measure distance to the second blade assembly; a second distance sensor mounted on the second blade assembly and configured and aimed to measure distance to the first blade assembly; and
a first sensor reference block fixedly mounted relative to a fixed datum and the first sensor being selectively movable to oppose the first sensor reference block;
the method comprising:
providing first stored reference data, measured relative to a first datum, for location of the second sensor and providing second stored reference data, measured relative to the first datum, for location of the first sensor reference block; providing third stored reference data, relative to a second datum, for location of the first sensor; and
during one measurement period of a cutting cycle, using the first sensor to determine a distance to a cutting face of the second blade assembly and using the second sensor to determine a distance to a cutting face of the first blade assembly;
in another measurement period of the cutting cycle, using the first sensor to determine a distance to the first sensor reference block; and
in a controller, calculating a blade gap from the stored reference data and determined distances.

13. A method according to claim 12, further comprising synchronizing each measurement period with a movement of the first blade assembly.

14. A method according to claim 12, further comprising the calculated blade gap comprises the distance from the first datum to the location of the second sensor, plus the sum of the distance between the first sensor and the cutting face of the second blade and the distance between the second sensor and the cutting face of the first blade, less the sum of the distance from the first datum to the location of the reference block and the distance from the first sensor to the first sensor reference block.

15. A method according to claim 12, wherein the method further comprises determining a required blade gap from reference data relating to material thickness for material to be sheared; comparing the required blade gap with the calculated blade gap, and if the result of the comparison exceeds a predetermined threshold range, adjusting the blade gap accordingly.
